(19) United States
(12) Patent Application Publication
(10) Pub. No.: US 2008/0257965 A1
(43) Pub. Date: Oct. 23, 2008

(54) CARD READER AND MACHINE SUPPLYING A SERVICE COMPRISING SUCH A CARD READER

(75) Inventors: Pierre Klein, Devecey (FR); Sebastien Descamps, Dole (FR)

Correspondence Address: YOUNG & THOMPSON, 209 Madison Street, Suite 500, ALEXANDRIA, VA, 22314, US

(73) Assignee: PARKEON, PARIS (FR)

(21) Appl. No.: 11/866,555

(22) Filed: Oct. 3, 2007

(30) Foreign Application Priority Data
Oct. 5, 2006 (FR) 06 08765

(51) Int. Cl. G06K 13/06

(52) U.S. Cl. 235/483

(57) ABSTRACT

The card reader includes a structure (12) for receiving a card limited by a housing for the card and also a slot (16) for insertion of the card into the housing, the receiving structure (12) including a portion (30A, 30B) for guiding the inserted card to a position within the housing for reading the card. The card reader also includes:
a sweeper (40) mounted so as to slide within the receiving structure (12) from a rear position located opposite the slot (16) clear of the housing to a forward position within the housing close to the slot (16), the sweeper (40) having a front surface (46) covering at least a part of the transverse cross-sectional surface area of the housing,
a mechanism (28) for operating the sweeper (40) to cause the sweeper (40) to slide from its resting position towards its forward position.

### TECHNICAL FIELD

This invention relates to a card reader.

The card to which the invention relates comprises a card, which is generally rectangular and of plastics material, on which a data medium, such as an integrated circuit, is attached.

The dimensions of the card are small: a few centimetres long and wide, of the order of one millimetre thick.

The invention applies particularly to the field of payment cards, which require a high level of security.

This type of card is more particularly described in standards ISO 7816-ISO IEC 7813/ISO 7810.

### BACKGROUND TO THE INVENTION

The use of a card reader of the type comprising a structure for receiving the card comprising both a housing for the card and a slot for inserting the card into the housing, the receiving structure comprising a portion guiding the inserted card to a position in the reading housing for the said card, is known from the state of the art.

A recurrent problem in the field of the invention is that of vandalism. This problem is even greater in the case of card readers which are not under surveillance, such as is for example the case for readers installed in pay stations on the highway.

One form of current vandalism comprises inserting objects which are not intended for the purpose into the reader through the slot. One object often found is a half card, that is a card which has been cut in a longitudinal direction.

One solution for overcoming this problem has been to provide a cavity extending below the level of the slot immediately behind the slot. Thus objects which are too small, such as half cards, fall into the cavity by gravity. Maintenance personnel thus only have to periodically collect the undesirable objects.

This is a relatively effective solution for vandalism which has in fact been widely adopted.

A card reader of this type is for example marketed by the Hopt & Schüler company under the reference “series 862”.

A card reader of this type is also known from document FR-A1-2 670 928.

Nevertheless the previously known solution has the disadvantage that it leaves the internal electronics of the reader and in particular the reading device accessible to maintenance personnel. There is therefore a significant risk that a spy device may be fitted.

### SUMMARY OF THE INVENTION

The object of the invention is to provide a card reader fitted with an anti-vandalism system which does not require the abovementioned cavity.

For this purpose the invention relates to a card reader of the aforesaid type, wherein it comprises:
a sweeper mounted so as to slide within the receiving structure from a rear position located opposite the slot and clear of the housing to a forward position in the housing, close to the slot, the sweeper having a front surface covering at least part of the transverse cross-sectional surface area of the housing,
a mechanism operating the sweeper to cause the said sweeper to slide from its resting position towards its forward position.

As a result of the invention, the sweeper can eject undesirable objects through the slot.

Furthermore, the invention has the advantage that it does not prevent vandalism as in the state of the art, which prevents the vandals from turning onto the machine and damaging it completely.

Furthermore the card reader according to the invention is compatible with the latest PCI PED (Payment Card Industry Pin Entry Device) standard which provides for the sensitive electronics to be enclosed within security walls.

According to other features of the invention:
the front surface covers more than 50% of the transverse cross-sectional surface area of the housing, preferably more than 75%,
in its forward position the sweeper is located less than 10 millimetres and preferably less than 5 millimetres from at least part of the slot,
the reader comprises a reading device in contact with the card, and
the sweeper is pierced from front to rear by a gap for the passage of the reading device,
the reader comprises lateral security walls which laterally enclose the receiving structure, and the driving mechanism is accessible from the exterior of the security walls,
the security walls conform to the PCI PED standard,
the operating mechanism comprises a lever, one end of which is intended to move the sweeper,
the lever has another extremity which extends outside the security walls through an opening provided for the purpose in one of the security walls,
the reader comprises a mechanism for returning the sweeper from its forward position to its rearward position,
the return mechanism comprises a return spring,
the return mechanism comprises the lever, the extremity designed to return the sweeper from front to rear being of one piece with the said sweeper,
the sweeper has the transverse form of a rake, and
the reader comprises a wall limiting the housing beneath, the said wall being provided with parallel grooves extending from front to back, and the sweeper in the form of a rake being engaged in the grooves.

The invention also relates to a machine for the provision of a service, in particular for the payment of car parking, wherein it comprises a payment card reader according to the invention.

According to other features of the invention:
the machine comprises a pivoting front providing access to the card reader, the said front prohibiting access to the operating mechanism when in the closed position,
the front is connected to the driving mechanism in such a way that opening of the front causes the sweeper to slide, and
the machine comprises a module for detecting that a card has been removed following a transaction, and a module for controlling the operating mechanism following detection.

### BRIEF DESCRIPTION OF THE DRAWINGS

The invention will be better understood from the following description provided purely by way of example and with reference to the appended drawings, in which:

FIGS. 1 and 2 are perspective views of a card reader according to the invention,

FIG. 3 is a view in cross-section of the card reader in FIGS. 1 and 2, and

FIG. 4 is a perspective view of the interior of the card reader in the preceding figures.

### DESCRIPTION OF PREFERRED EMBODIMENTS

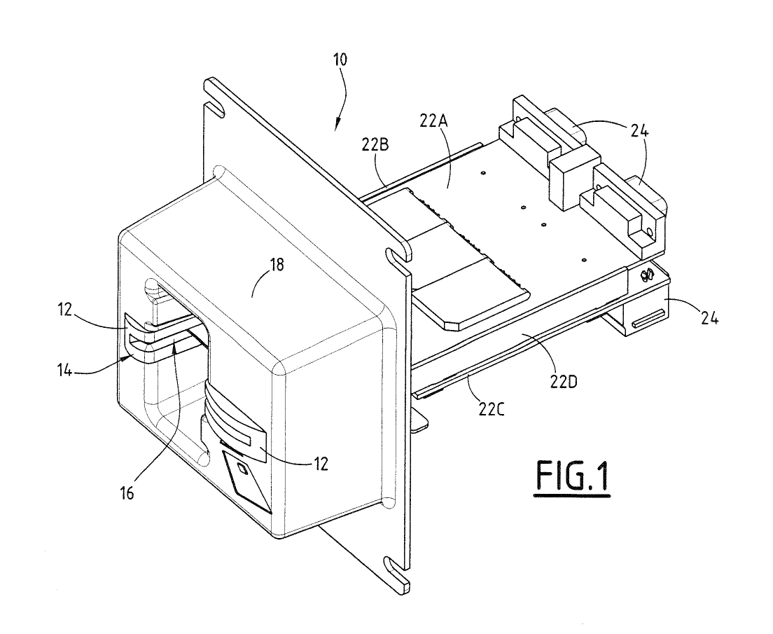

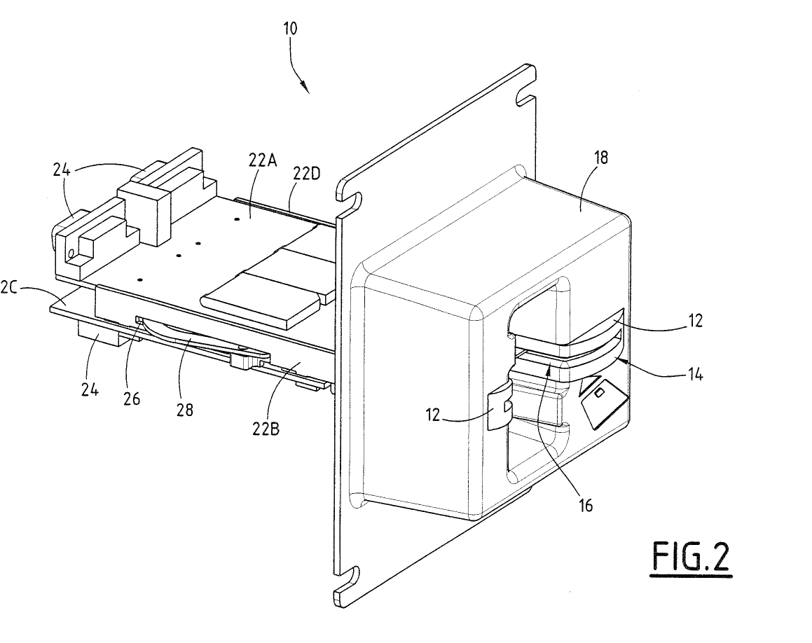

With reference to FIGS. 1 and 2, a card reader 10 is illustrated. This card reader 10 is designed to be located in a pay station used to manage the car parking payments.

In the rest of the description the terms “front”, “rear”, etc., refer to the front and rear of the pay station. The front of the pay station is defined as the part of the pay station which the user faces and with which it interacts. The rear of the pay station is defined as the part away from the user.

The pay station comprises a front in which card reader 10 is embedded.

The front pivots and can be opened for access to the internal components of the pay station, in particular card reader 10. When in the closed position the front prevents access to the card reader except through slot 16.

Card reader 10 comprises a structure 12 for receiving a smart card.

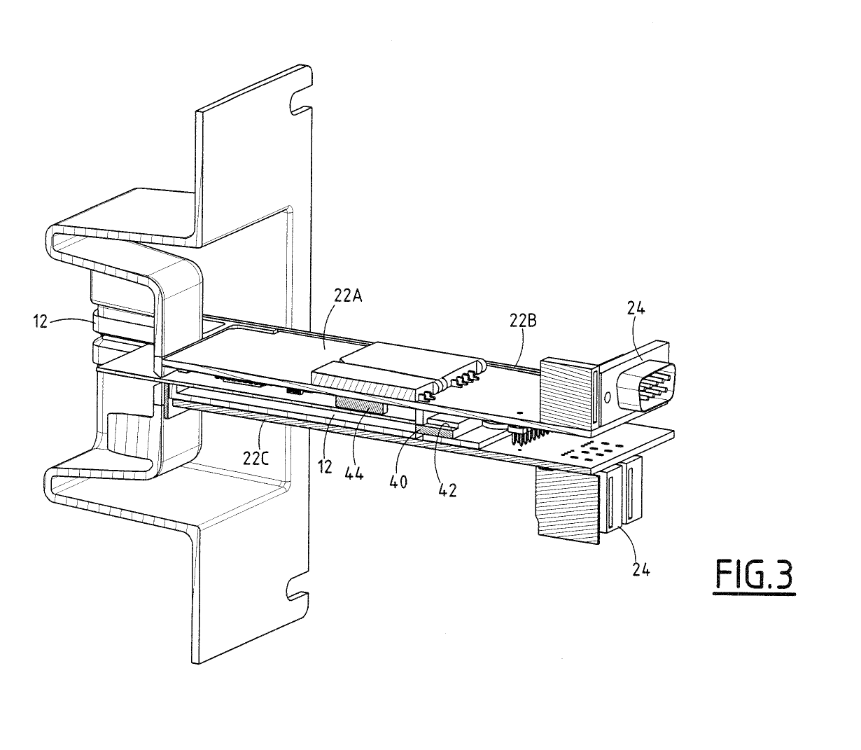

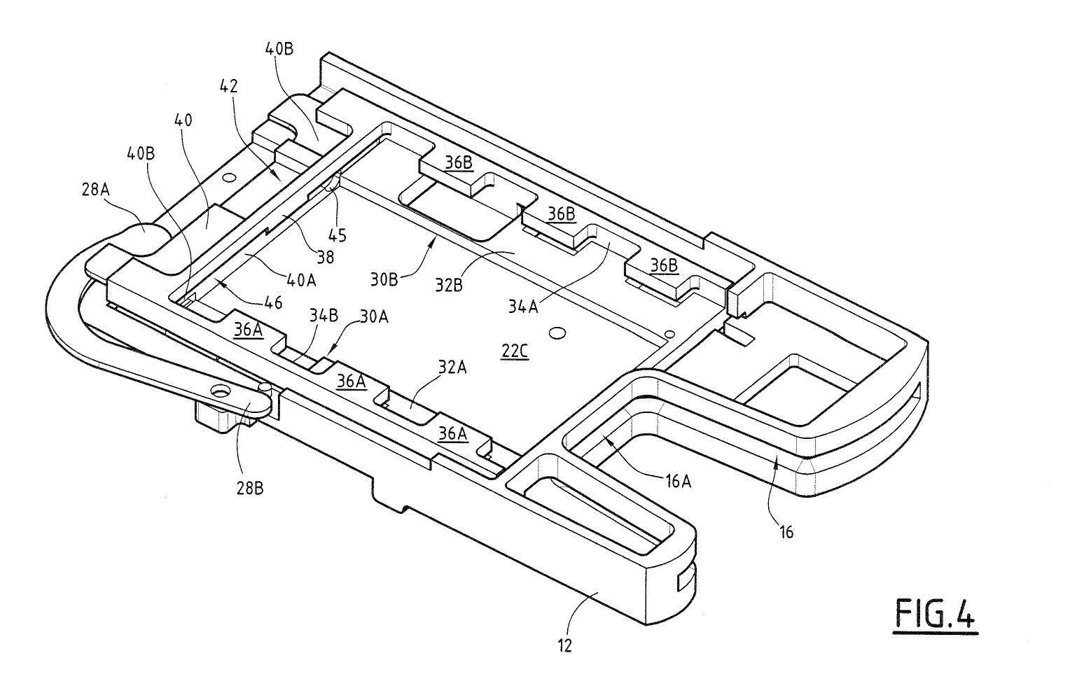

In FIGS. 1 and 2, only the front surface 14 of introduction structure 12 can be seen. This front face 14 encompasses a slot 16 for insertion of the card. The rest of the structure 12 will be described in greater detail below with the help of FIGS. 3 and 4.

Slot 10 follows a horizontal line of general U-shape. Slot 16 therefore has a “deep” part 16A corresponding to the base of the U. A front casing 18 covers the front of the insertion structure. Front casing 18 has a recess 20 corresponding to the shape of slot 16 so that the card can be grasped in order to withdraw it.

Behind front casing 18 four lateral security walls 22A, 22B, 22C, 22D enclose receiving structure 12 laterally.

Security walls 22A, 22B, 22C, 22D are for example such that piercing or dismemberment thereof results in destruction of the information stored in the reader. This can be achieved in particular by laying down a conducting mesh on walls 22A, 22B, 22C, 22D, breakage of this mesh resulting in the deletion of data from the reader.

Upper 22A and lower 22C security walls bear electronic components for processing card data (only those borne on the outer surfaces of the walls are visible in FIGS. 1 and 2) and in particular connectors 24 located at the back and intended to exchange data with other components of the machine, for example an alphanumeric keyboard on which the user enters his secret code.

Preferably, sensitive operations, such as comparison between the code entered on the keyboard and the code stored in memory on the card are carried out by electronics protected within walls 22A, 22B, 22C, 22D.

Connection of card reader 12 through connectors 24 also makes it possible to enclose the rear of the envelope formed by front case 18 and walls 22A, 22B, 22C, 22D.

Side wall 22B, located on one side of card reader 12, is pierced by an opening 26 for the passage of a lever 28. Lever 28 is mounted so that it can pivot with respect to receiving structure 12 about a vertical axis. Preferably opening 26 is adjusted as tightly as possible to the dimensions of lever 28 so as to again minimise risks of intrusion.

With reference to FIGS. 3 and 4, receiving structure 12 comprises a guiding portion formed of two parallel slides 30A, 30B which extend from the front to the rear of reader 10.

Each slide 30A, 30B comprises a rail 32A, 32B, a lateral guide wall 34A, 34B and a series of tongues 36A, 36B which extend above rail 32A, 32B. The card is thus guided horizontally between the two guide walls 34A, 34B, and vertically between rails 32A, 32B and tongues 36A, 36B. It will be noted that the card is guided directly, that is to say it is in contact with slides 30A, 30B, within which it slides.

A stop 38 stopping the card is provided at the rear of reader 10. When the card abuts against stop 38 the card is in the reading position. It then only projects through part 16A of the slot so it can be withdrawn by the user.

The space limited horizontally between rails 32A, 32B and tongues 36A, 36B, longitudinally between slot 16 and stop 38 and vertically by guide walls 34A, 34B, defines the card housing. In other words, this is the volume occupied by the card in the reading position within reader 10.

Card reader 12 also comprises a sweeper 40 mounted so as to slide in slides 30A, 30B from a rear position illustrated in FIG. 3 to a forward position.

Sweeper 40 has the general shape of a rectangular bar orientated transversely and horizontally. A central portion 40A extends from one slide to the other, and downwards against lower security wall 22C. This central part 40A rises up to the level of tongues 36A, 36B with the exception of a gap 42 which extends from front to rear of sweeper 40 and is orientated upwards.

This gap 42 allows a reading device 44 fixed on upper security wall 22A to move downwards. In the example described, the reading device is a coupler intended to come into contact with the integrated circuit on the card.

A cylindrical notch 45 is also placed in recess 42, towards the front, in such a way as to house therein an activator which makes contact with a switch (not shown) indicating that the card is inserted as far as the stop.

Central part 40A is extended lengthwise by two longitudinal members 40B each resting on a rail 30A, 30B and also extending as far as tongues 36A, 36B.

Thus sweeper 40 is provided with a front surface 46 covering the entire surface area of the housing and transverse cross-section with the exception of gap 42 for the passage of reading device 44. In practice front surface 46 covers more than 50% of the aforesaid surface area, preferably more than 75%.

Furthermore, front surface 46 fully covers the transverse cross-sectional surface area of the space separating the housing from lower wall 22C.

The rear position of sweeper 40 is located opposite slot 16 and is clear of the housing so as not to interfere with the insertion of the card. It will be noted that for this purpose slides 30A, 30B extend backwards beyond stop 38.

The forward position of sweeper 40 is located close to slot 16, at a distance of less than 10 millimetres, preferably less than 5 millimetres, from the deep part 16A of slot 16.

Lever 28 has one extremity 28A located behind sweeper 40 which is designed to move sweeper 40 forward.

Lever 28 also has another extremity 28B extending beyond the exterior of the envelope formed by the security walls, as may be seen in FIG. 2.

The operation of card reader 10 when ejecting undesirable objects present in the housing will now be described.

The maintenance operator opens the front of the pay station. He causes lever 28 to pivot by pulling on its extremity 28B. In response to this extremity 28A moves forward and pushes sweeper 40 until the latter reaches its forward position. Lever 28 therefore forms a mechanism for operating sweeper 40.

As it slides, front surface 46 sweeps the volume of the housing and ejects any undesirable objects which may be located there.

In an embodiment which is not shown, the sweeper has the transverse shape of a rake.

Preferably, the reader comprises a wall limiting the housing from beneath, the said wall being provided with parallel grooves extending from front to back. The sweeper in the shape of a rake then engages the grooves.

In another embodiment not illustrated, the forward position of the sweeper is such that the front surface of the sweeper obstructs the slot in such a way as to be flush with the latter at least over part of its length. This ensures that undesirable objects are properly ejected, even if they are small.

In another embodiment not shown, the front surface has a shape which matches that of the slot. This reduces the risk of an object remaining within the housing, between the sleeper and the slot, in an area where the two are relatively far from each other.

In an improvement which is not illustrated the front is connected to the operating mechanism in such a way that opening of the front causes the sweeper to move forwards.

As an alternative, the pay station comprises a module to detect that the card has been withdrawn from the reader following a transaction, and a module controlling the operating mechanism following detection.

In another improvement which is not illustrated the card reader comprises a mechanism for returning the sweeper to its rear position from its forward position.

This is achieved for example by using a return spring.

As a variant, the return mechanism comprises the lever itself, the extremity intended to move the sweeper of one piece with the sweeper from front to rear. Thus the operator automatically places the sweeper back in its rear position when he replaces the lever.

1. A card reader comprising
a structure for receiving a card limited by a housing for the card and also a slot for insertion of the card into the housing, the receiving structure comprising a portion for guiding the inserted card to a position within the housing for reading the said card,
a sweeper mounted so as to slide within the receiving structure from a rear position located opposite the slot and clear of the housing to a forward position within the housing close to the slot, the sweeper having a front surface covering at least part of the transverse cross-sectional surface area of the housing, and
a mechanism for operating the sweeper to cause the said sweeper to slide from its resting position towards its forward position,
the reader being wherein the front surface covers more than 50% of the transverse cross-sectional surface area of the housing, preferably more than 75%.

2. A card reader according to claim 1, wherein when in the forward position the sweeper is located less than 10 millimetres, preferably less than 5 millimetres from at least a part of the slot.

3. A card reader according to claim 1, wherein it comprises a reading device through contact with the card, and that the sweeper is pierced from front to rear by a gap for passage of the reading device.

4. A card reader according to claim 1, wherein it comprises lateral security walls laterally enclosing the receiving structure and in that the operating mechanism is accessible from outside the security walls.

5. A card reader according to claim 4, wherein the security walls comply with the PCI PED standard.

6. A card reader according to claim 4, wherein the operating mechanism comprises a lever, one extremity of which is intended to move the sweeper.

7. A card reader according to claim 6, wherein the lever has another extremity extending beyond the security walls through an opening provided for this purpose in one of the security walls.

8. A card reader according to claim 6, wherein it comprises a mechanism for returning the sweeper from its forward position to its rear position.

9. A card reader according to claim 8, wherein the returning mechanism comprises a return spring.

10. A card reader according to claim 8 taken together, wherein the return mechanism comprises the lever, the extremity intended to return the sweeper of one piece with the said sweeper from front to rear.

11. A card reader according to claim 1, wherein the sweeper has the transverse shape of a rake.

12. A card reader according to claim 11, wherein it comprises a wall limiting the housing from beneath, the said wall being provided with parallel grooves extending from front to rear, and in that the sweeper in the form of a rake engages the grooves.

13. A machine for the provision of a service, in particular for the payment of car parking, wherein it comprises a payment card reading according to claim 1.

14. A machine according to claim 13, wherein it comprises a pivoting front for access to the card reader, the said front preventing access to the operating mechanism when in the closed position.

15. A machine according to claim 14, wherein the front is connected to the operating mechanism in such a way that opening of the front causes sliding of the sweeper.

16. A machine according to claim 13, wherein it comprises a module detecting that the card has been withdrawn following a transaction, and a module controlling the operating mechanism following detection.

17. A card reader according to claim 1, wherein it comprises a mechanism for returning the sweeper from its forward position to its rear position.

18. A card reader according to claim 5, taken together with claim 7, wherein the lever has another extremity extending beyond the security walls through an opening provided for this purpose in one of the security walls.

19. A card reader according to claim 1, wherein the operating mechanism comprises a lever, one extremity of which is intended to move the sweeper.
